(19) United States
(12) Patent Application Publication
(10) Pub. No.: US 2004/0066947 A1
(43) Pub. Date: Apr. 8, 2004

(54) Transducer with multiple phase plugs

(76) Inventor: Earl Rossell Geddes, Northville, MI (US)

Correspondence Address: Earl Geddes, 43516 Scenic Lane, Northville, MI, 48167, US

(21) Appl. No.: 10/265,476

(22) Filed: Oct. 4, 2002

(51) Int. Cl. H04R 1/02; H04R 1/20

(52) U.S. Cl. 381/343

(57) ABSTRACT

An acoustic transducer which can have a multiplicity of different phasing plugs is disclosed.

### BACKGROUND

1. Field of the Invention

The present invention relates to the use of interchangeable phase plugs in an electro-acoustic transducer composed of drive-unit and waveguide assemblies.

2. Description of Prior Art

In high performance audio playback systems it is common practice to use wave guiding devices coupled to an electro-acoustic transducer drive-unit (that portion of an electro-acoustic transducer that does the direct electrical to acoustical transduction) that act to both amplify and direct the sound energy created therein. These devices go by many names, the most common being “waveguides” and “horns”. I will use the term waveguide to mean any and all devices performing such tasks.

The “shape” (magnitude and phase) of the wavefront presented to the waveguide at its input end (the throat) has a great influence on how the device radiates sound from the open end (the mouth), particularly at the higher frequencies. In order to control the formation of the throat wavefront it is common practice to place a plug containing multiple sound paths between the audio transducer and the throat of the waveguide. This plug is designed so as to direct the sound waves emitted from the drive-unit into the throat in a prescribed shape. This plug is also know by various names, the most common being “phase plug”, “phasing plug” or “equalizer”.

The art of phase plug design is well advanced. The first significant disclosure of the function of a phase plug is provided by Wente, U.S. Pat. No. 2,037,187 (1936). Wente notes that the goal is to provide an essentially planar wavefront at the horn throat and he achieves this task by directing the sound through channels of essentially equal length, thereby ensuring that the contributions all add in phase.

In Henricksen, U.S. Pat. No. 4,050,541 (1977), an alternate type of phase plug wherein the sound directing channels are radial, as opposed to circumferential, is disclosed.

Carlson, U.S. Pat. No. 4,718,517 (1988), discloses a phase plug which has a rectangular exit aperture at the throat and couples to a circular drive-unit diaphragm.

Adamson, U.S. Pat. No. 4,975,965 (1990) discloses a loudspeaker with a phase plug which is coupled to a drive-unit diaphragm that has both convex spherical and concave conical sections. Of note in this patent is the fact that the phase plug is a separate part of the assembly. Adamson does not discuss, nor has he ever made available to the public more than the singular phase plug that is distributed with the product.

Bie, U.S. Pat. No. 5,117,462 (1992), utilizes the voice coil motion as part of the radiating surface of the drive-unit and adds a sound channel to said radiating region.

Finally, Keith, U.S. Pat. No. 6,064,745 (2000), discloses an improved radial type of phase plug which is easier to manufacture than previous designs.

Each of these inventions claims a distinct improvement over the others in regard to performance, manufacturability and/or some other comparable, however, non of them recognizes the possibility of using more than one design for a given drive-unit. The Adamson invention would allow for such a possibility, although he did not disclose any recognition of this possibility, nor has he ever utilized it in practice.

Adamson acknowledged in U.S. Pat. No. 4,975,965 (column 5, lines 56-64) that his phase plug “has been found to be particularly useful when applied to acoustic waveguide speakers of the variety developed by Dr. E. R. Geddes . . .”—the current inventor. The waveguide referred to by Adamson was based on the oblate spheroidal coordinate system. In Chapter 6 of my book Audio Transducers, (GedLee Publishing, July, 2002), I discuss the fact that there are several different coordinate systems which yield useful waveguides (see table 6.1 in the text) and that each one has a different set of radiation characteristics. As discussed in this text, these different waveguides require different wavefront shapes at the throat (“source aperture” and “curvature” in the table of my text) for optimum performance. This means that a drive-unit which is intended to utilize different waveguides—i.e. when different polar patterns are desired—should have different phase plugs if it is to be optimally matched to the waveguide.

In none of the prior art disclosures is it recognized that one might want to use different phase plugs with a given drive-unit for use with different waveguides. It was generally assumed that the phase plug should create a planar (uniform phase and magnitude) wavefront at a circular exit aperture (i.e. the throat of the waveguide) and that the waveguide throat is adapted to match the phase plug's exit aperture—not the other way around. Not only is a plane wavefront in a circular aperture at the exit of the phase plug not always optimum for a waveguide, the optimum wavefront and exit aperture is different for different waveguides.

In order to allow for an optimal matching of a drive-unit to a waveguide, it would be desirable to be able to use different phase plugs when different waveguides are used.

### OBJECTS AND ADVANTAGES

It is the primary object of this invention to disclose a mechanism whereby a given drive-unit can have multiple interchangeable phase plug options. The advantage of this invention is to provide a means for optimally matching a given drive-unit to different waveguides by the use of interchangeable phase plugs which provide this optimal match. This is a distinct advantage over a drive-unit with a fixed phase plug.

### DRAWING FIGURES

FIG. 1 shows a top view of a phase plug of conventional design;

FIG. 2 shows an exploded view of the axi-symmetric cross section 0-A of a phase plug and the preferred embodiment for the attachment of the phase plug to the waveguide and drive-unit;

FIG. 3 shows a top view of a phase plug with an elliptical exit aperture for use on an ellipsoidal coordinate system waveguide;

FIG. 4 shows a top view of a phase plug with a rectangular exit aperture for use on an prolate spheroidal or elliptic cylinder coordinate system waveguide.

### REFERENCE NUMERALS IN DRAWINGS

| | |
|---|---|
| 10 generic drive-unit | 30 waveguide |
| 20 interchangeable phase plug | 40 attachment bolt |

### SUMMARY

In accordance with the present invention, the ability to optimally adapt a given drive-unit to an assortment of waveguides by using interchangeable phase plugs is disclosed.

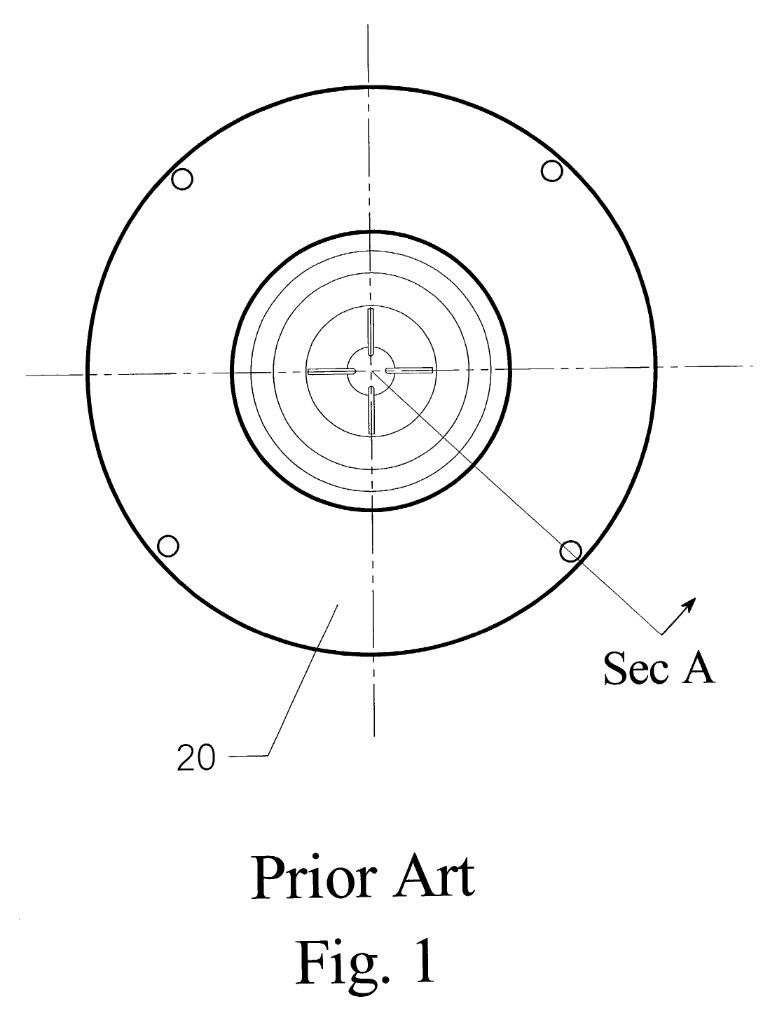

### Description FIGS. 1 to 4

Since there can be many ways to assemble a drive-unit, phase plug and waveguide together only a typical structure will be shown.

In the prior art a circular exit aperture from the phase plug (20) is coupled to the circular input of a waveguide as shown in FIG. 1.

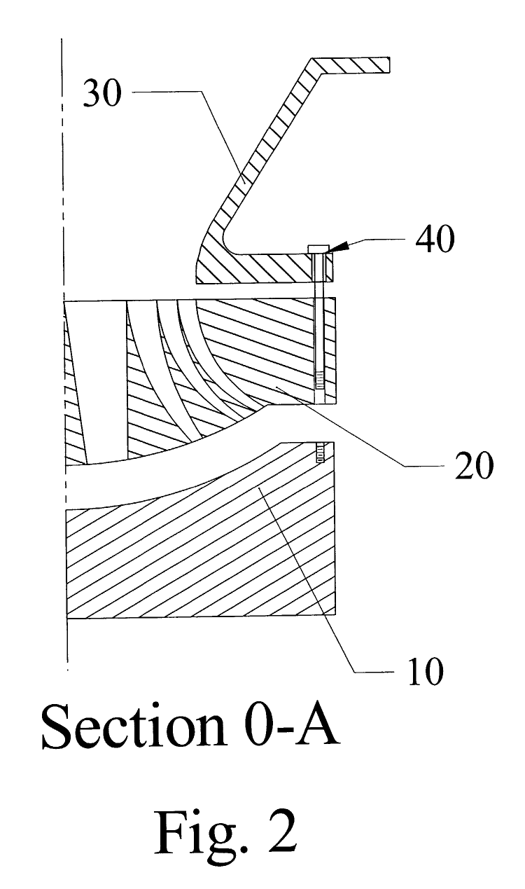

In FIG. 2 a means for connecting a waveguide (30) to a drive-unit (10) can be seen. The phase plug (20) is held in place by a compression connection created by the joining of the waveguide and the drive-unit with bolts (40). It is equally feasible to connect the phase plug directly to the drive-unit and then connecting the waveguide to the phase plug or again, directly to the drive-unit. The details of the phase plug design, as shown in the figure are not significant. It is the ability to connect alternate designs that is the key invention of this application.

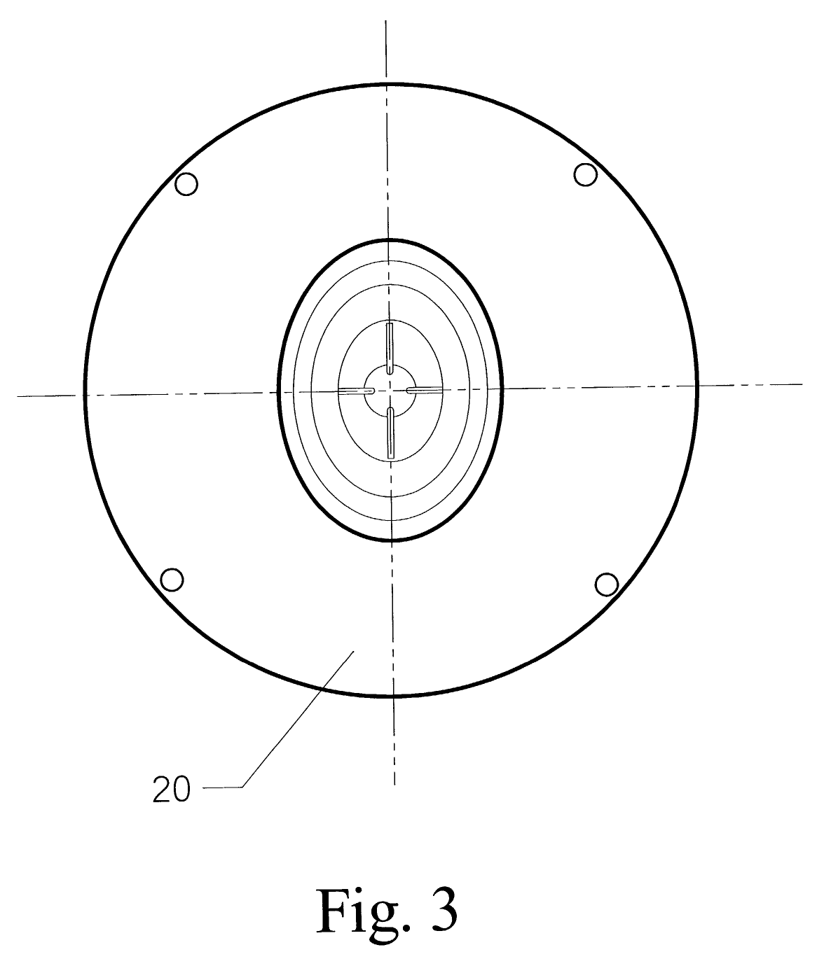

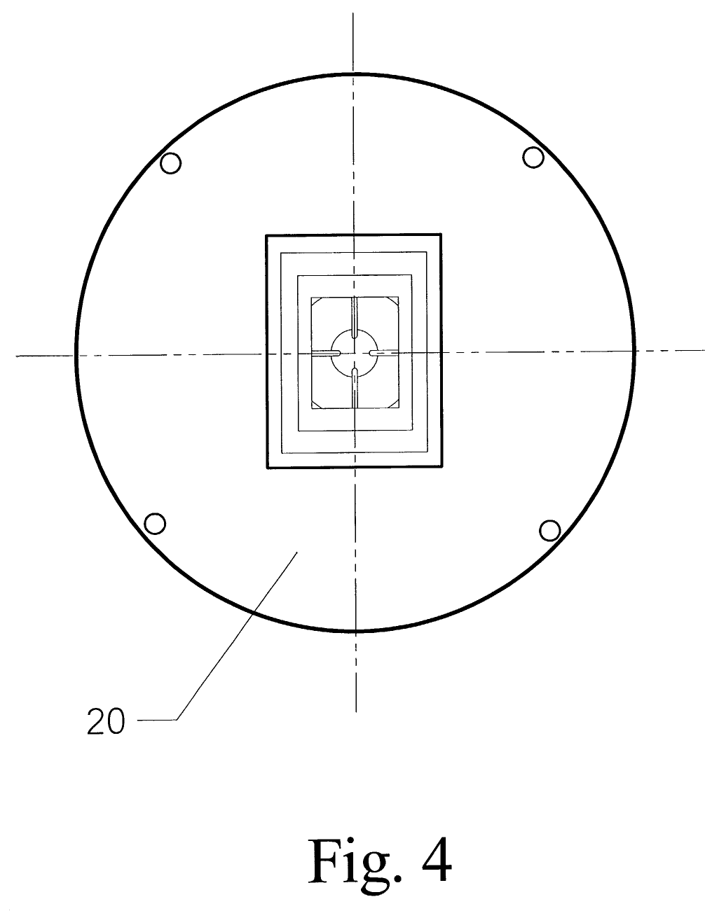

FIG. 3 and FIG. 4 show alternate phase plug exit aperture configurations that one might use in the context of this disclosure.

One skilled in the art will recognize that there are many ways to assemble an electro-acoustic transducer composed of a drive-unit, phase plug and waveguide and that the method of assembly shown here is but one. For example, the diaphragm could also be placed convex side out (as opposed to that shown in FIG. 2), or the voice coil and magnet structure might be opposite to that implied by the figures. So long as there is more than one phase plug utilized in the design, these details do not affect the significance of the disclosure presented here in any way.

I claim:

1) An electro-acoustic transducer for creating sound comprising:
a drive-unit;
a waveguide and;
at least two interchangeable phase plugs.

2) An electro-acoustic transducer as defined in claim 1 wherein:
one of said interchangeable phase plugs has an elliptical exit aperture.

3) An electro-acoustic transducer as defined in claim 1 wherein:
one of said interchangeable phase plugs has a rectangular exit aperture.
